(19) United States
(12) Patent Application Publication
(10) Pub. No.: US 2009/0263656 A1
(43) Pub. Date: Oct. 22, 2009

(54) Organic-inorganic hybrid structures having nanoparticles adhering thereon and method for preparing the same

(76) Inventors: Byung-Joon Chae, Daejoen (KR); Sung-Ho Yoon, Daejeon (KR)

Correspondence Address: MCKENNA LONG & ALDRIDGE LLP, 1900 K STREET, NW, WASHINGTON, DC, 20006, US

(21) Appl. No.: 12/311,686

(22) PCT Filed: Oct. 10, 2007
(86) PCT No.: PCT/KR2007/004921

§ 371 Date: Apr. 9, 2009

(30) Foreign Application Priority Data
Oct. 11, 2006 (KR) 10-2006-0098739

(51) Int. Cl. C08G 79/00; B32B 1/00

(52) U.S. Cl. 428/400; 528/9; 977/773; 977/810

(57) ABSTRACT

The invention disclosed herein provides an organic-inorganic hybrid structure having nanoparticles attached to the surface thereof, wherein the structure comprises a self-assembled structure of a coordination polymer, which includes a metal-organic ligand complex, as well as a preparation method thereof. According to the invention, through the use of the self-assembly phenomenon of coordination polymer and the use of nanoparticles having a surface component, which is the same as or similar to that of the surface of the coordination polymer, an organic-inorganic hybrid structure, which has nanoparticles attached to the surface of a self-assembled structure of coordination polymer, can be prepared in a relatively simple process without needing several steps.

### TECHNICAL FIELD

The present invention relates to an organic-inorganic hybrid structure, which has nanoparticles attached to the surface of a self-assembled structure of coordination polymer, and to a preparation method thereof.

### BACKGROUND ART

Nano-technology (NT), which has been highlighted together with information technology (NT) and bio-technology (BT), includes two approaches: the top-down approach and the bottom-up approaches. The bottom-up approach refers to a method of assembling building blocks into the desired shapes having a larger size. Also, it has received attention as an easy method in which the loss of material and energy is reduced compared to that of the top-down approach in which etching and grinding are mainly carried out. Particularly, self-assembly refers to the process in which specific building blocks (individual atoms or molecules, fine particles having a specific shape, etc.) are physically or chemically spontaneously arranged (or bonded) in a given manner and direction to grow larger. Also, the self-assembly forms the basis of biological phenomena in nature and has received the attention of scientific technicians for a long time.

Although most materials show the desired properties from the molecular viewpoint, the properties thereof mostly disappear, when the arrangement of molecules is in a disordered form from the macroscopic viewpoint. However, self-assembling materials and fine structures prepared therefrom will offer a breakthrough for the development of novel materials, because the prediction and design of the desired shapes and physical properties are possible.

Meanwhile, with regard to organic-inorganic composite nanomaterials which have been studied for their applicability as electronic materials, optical materials, information storage media and the like, various synthesis methods, including methods which use polymers, have been studied. Specifically, various composite materials, including core-shell composite materials, or composite materials comprising inorganic particles dispersed in polymer matrices, are known, and surfactant-coated inorganic materials are also known. However, such composite materials have shortcomings in that preparation processes thereof are complicated, and the loss of materials is large, because processes of synthesizing the materials thereof separately, and then making the composite materials using the separately synthesized materials, are carried out.

In addition, studies on organic-inorganic hybrid materials having nanoparticles (e.g., metal nanoparticles) attached to the surface thereof have not been actively conducted, and there is no report showing the formation of a structure in which nanoparticles are attached directly to the surface of an organic-inorganic hybrid material without using covalent bonding.

### DISCLOSURE OF THE INVENTION

The present inventors have found that organic ligand-metal complexes can be bonded in a chain manner to form a coordination polymer, the coordination polymer can be self-assembled by intermolecular interaction to form a self-assembled structure having a specific shape and, at the same time, nanoparticles stabilized by a surfactant can be attached to the surface of the self-assembled structure by interaction between the nanoparticles and the surface of the self-assembled structure, thus forming an organic-inorganic hybrid structure.

Also, the present inventors have found that the formation of the self-assembled structure of coordination polymer, the formation of the nanoparticles, and the adhesion of the nanoparticles to the surface of the self-assembled structure, can also be simultaneously performed in one reactor, and the component of the nanoparticles that can be attached to the surface of the self-assembled structure may be the same as or different from the metal contained in the organic ligand-metal complex.

Therefore, it is an object of the present invention to provide an organic-inorganic hybrid structure, having nanoparticles attached to the surface of a self-assembled structure of coordination polymer, as well as a preparation method thereof.

To achieve the above object, in one aspect, the present invention provides an organic-inorganic hybrid structure having nanoparticles attached to the surface thereof, wherein the structure comprises a self-assembled structure of a coordination polymer, which includes a metal-organic ligand complex.

In another aspect, the present invention provides a method for preparing said organic-inorganic hybrid structure, having nanoparticles attached to the surface of a self-assembled structure of coordination polymer, the method comprising the steps of: a) dissolving a metal-organic ligand complex and a reducing agent in a solvent; heating the solution at a temperature of 25-250° C. so as to allow it to react; and c) cooling the reaction solution to room temperature.

In still another aspect, the present invention provides a method for preparing said organic-inorganic hybrid structure, having nanoparticles attached to the surface of a self-assembled structure of coordination polymer, the method comprising the steps of: a) preparing nanoparticles, the surface of which has been stabilized by a surfactant; b) dissolving a metal-organic ligand complex in a solvent, and allowing the solution to react at a temperature of 25-250° C. so as to prepare a self-assembled structure of coordination polymer; and c) adding the nanoparticles of step a) to the solution of step (b) so as to attach the nanoparticles to the self-assembled structure.

Hereinafter, the present invention will be described in detail.

Formation of Coordination Polymer

As used herein, the term “coordination polymer” refers to a kind of organic-inorganic hybrid compound, which is a polymeric material in which metal ions and organic ligands are linked alternately and three-dimensionally. The coordination polymer is also called “metal-organic framework” (MOF). Herein, the metal ions are also designated as connectors, and the organic ligands are also designated as linkers.

More specifically, the coordination polymer in the present invention may include a material in which organic ligands are coordinately bonded to two or more metal atoms, and the coordinately bonded metal atoms are also coordinately bonded to one or more other organic ligands in a chain manner, thus forming a network (see FIG. 1).

Moreover, the coordination polymer may also be a material in which two metal ions are bonded with two 2-coordinate organic ligands to form ring-shaped dimers, and the dimers are bonded to each other, thus forming the coordination polymer (see FIG. 2).

The principle of the formation of the coordination polymer will now be described by way of an example of Ag-palmitate (CH₃(CH₂)₁₄COOAg) illustrated in FIGS. 1 and 2. It is to be understood, however, that the scope of the present invention is not limited to materials illustrated below.

Palmitate consists of straight-chain alkyl and carboxylate (—COO—), and can be coordinately bonded to two Ag atoms, because the carboxylate offers a site capable of forming coordinate bonds with two metal atoms. Because the Ag atom tends to form a linear chain in the coordination polymer, an Ag atom, bonded with one palmitate, can be coordinately bonded to another adjacent palmitate, and if such bonding occurs in a chain manner, a coordination polymer having a two-dimensional planar structure can be formed. In the Ag-palmitate coordination polymer, Ag as a connector and carboxylate as a linker are connected two-dimensionally, in which hydrophilic Ag and carboxylate groups are located at the center, and the hydrophobic alkyl group is located at the end (see FIG. 1).

A coordination polymer according to another embodiment of the present invention may be a polymer in which two Ag ions are coordinately bonded to two carboxylates to form 8-membered ring dimers (e.g., Ag₂(O₂CR)₂), which are then polymerized by the weak Ag—O bond to form 4-membered rings, which are then linearly bonded to each other to form a chain coordination polymer (see FIG. 2).

In this case, the alkyl groups of the carboxylate are present substantially perpendicular to the linear backbone consisting of Ag and —COO, double bladed comb-shaped chains form two-dimensional layers through the planar interaction between them, and the two-dimensional layers are more orderly stacked through the effective interaction between the alkyl groups, thus forming a self-assembled structure of coordination polymer as described below.

Formation of Self-Assembled Structure of Coordination Polymer

As used herein, the term “self-assembly” refers to the process in which specific building blocks (individual atoms or molecules, fine particles having a specific shape, etc.) are physically or chemically spontaneously arranged (or bonded) in a given manner and direction to grow larger. The driving force for such self-assembly is the physical/chemical attraction between units, and non-limiting examples thereof include hydrogen bonding, Van der Waals force, electrostatic force, capillary phenomena, the interaction between hydrophobic groups or hydrophilic groups, metal-ligand bonding, and covalent bonding, etc. In the self-assembly of coordination polymer according to the present invention, the driving force for the self-assembly is preferably the interaction between hydrophobic groups or hydrophilic groups.

The Ag-palmitate coordination polymer illustrated in FIG. 1 may have a form in which the alkyl chains extend outward with respect to Ag, and 4-5 carbon atoms in the alkyl chain end interact with 4-5 carbon atoms in another alkyl chain end so as to form intermolecular bonds. Through such bonding, the self-assembly of the coordination polymer can be achieved, and in this case, the interaction between hydrophilic groups and hydrophobic groups is considered to be the driving force for the self-assembly.

Meanwhile, depending on reaction conditions and the like, the coordination polymer can be self-assembled in a specific orientation or uniformly assembled, thus forming a structure having a specific shape (e.g., a wire shape, a plate shape, a sphere shape, etc.).

For example, Ag palmitate is generally present in the state of coordination polymer and has a micrometer-sized flake-like morphology, and thus it has poor solubility in solvents. However, when it is heated close to the boiling point in benzene ring-containing solvents (excluding nitro-benzene), such as toluene, benzene, dichlorobenzene or xylene, it will be completely dissolved, and when the heated solution is cooled, it can be seen that it is changed into a micro-wire-like morphology due to the self-assembly of the coordination polymer.

Meanwhile, in the present invention, in order for the coordination polymer containing an organic ligand-metal complex to form a self-assembled structure, the organic ligands may have both a hydrophilic group and a hydrophobic group. As used herein, the term “hydrophilic group” means a polar group having a strong affinity for water, and the term “hydrophobic group” means a non-polar group, having a low affinity for water and a high affinity for oil. The definition of the hydrophobic group and the hydrophobic group in the present invention may include all hydrophilic groups and hydrophobic groups, which are widely known to those skilled in the art.

As in the above-described example of Ag-palmitate, the hydrophilic group can contribute to the formation of the coordination polymer through coordinate bonding with metal atoms, and the hydrophobic group can contribute to the formation of the self-assembled structure through interaction with hydrophobic groups contained in other building blocks of the coordination polymer.

Herein, although the hydrophilic group is not specifically limited, non-limiting examples thereof may include —COO, —NH₂, —CONH₂, —PO₃H₂, —SH, —SO₃H, —SO₂H, —NO₂, and —O(CH₂CH₂O)ₙH wherein n is an integer from 1 to 5. These hydrophilic groups may be used alone or in a mixture of two or more. Also, non-limiting examples of the hydrophobic group may include a C₃-C₃₀ alkyl group and a C₃-C₃₀ aryl group, and these hydrophobic groups may be used alone or in a mixture or two or more.

Also, non-limiting examples of the organic ligand include propionate, butyrate, pentanoate, hexanoate, heptanoate, octanoate, nonate, decanoate, neodecanoate, palmitate and the like.

Meanwhile, although metal atoms, which can be contained in the organic ligand-metal complex, are not specifically limited, may be metals, metalloids, lanthanide metals and actinide metals, which belong to groups 3-16 of the periodic table, and non-limiting examples thereof include Ag, Cu, Au, Cr, Al, W, Zn, Ni, Fe, Mn, Pt, Pd, Co, V, Ti, Pb, Cd, and the like.

Self-Assembled Structure of Coordination Polymer, Having Nanoparticles Attached Thereto

A self-assembled structure of coordination polymer according to the present invention is characterized in that it has nanoparticles attached to the surface thereof.

The nanoparticles have a size ranging from 1 nm to 500 nm, may contain at least one selected from the group consisting of metals, metalloids, lanthanide metals and actinide metals, belonging to groups 3-16 of the periodic table, alloys of two or more of said elements, the oxides of said elements and semiconductor compounds, non-limiting examples of which include Ag, Cu, Au, Cr, Al, W, Zn, Ni, Fe, Mn, Pt, Pd, Co, V, Ti, Pb, Cd, or alloys thereof, metal oxides, such as ZnO, TiO₂, SiO₂, Al₂O₃, ZrO₂, WO₃, NiO and Fe₂O₃, and semiconductor compounds, such as ZnS, CdSe and CdS. Herein, the nanoparticles may contain the same metal element as the metal contained in the coordination polymer.

An organic compound having a hydrophobic group or a hydrophilic group, preferably a surfactant, may be attached to the surface of the nanoparticles, whereby the chemical stability of the nanoparticles can be enhanced, and the dispersibility of the nanoparticles in a solution can also be improved.

Meanwhile, if a hydrophobic group or a hydrophilic group is present on the surface of the self-assembled structure of coordination polymer, it can interact with the hydrophilic group or hydrophobic group of the organic compound attached to the surface of the nanoparticles, and thus the adhesion of the nanoparticles to the surface of the self-assembled structure can be easily achieved. Accordingly, it is preferable that a functional group present on the surface of the self-assembled structure of the coordination polymer, and a functional group at the end of the organic compound attached to the surface of the nanoparticles be the same or can interact with each other.

A method for preparing the above-described self-assembled structure of coordination polymer, having nanoparticles attached to the surface thereof, may be: A) a method in which the self-assembly reaction of coordination polymer and the formation and adhesion of nanoparticles are simultaneously performed in one reactor; or B) a method in which nanoparticles are separately prepared, and then the nanoparticles are added during the self-assembly reaction of the coordination polymer so as to attach them to the self-assembled structure.

Method A) in Which Self-Assembly Reaction and Nanoparticle Formation and Adhesion are Simultaneously Performed

The preparation method according to the present invention may comprise the steps of:
a) dissolving a metal-organic ligand complex and a reducing agent in a solvent;
b) heating the solution to a temperature of 25-250° C. to allow the solution to react; and
c) cooling the reaction solution to room temperature.

Through the above-described steps, a series of the following processes can simultaneously occur in one reactor:
1) the formation of coordination polymer by the coordinate bonding between organic ligands and metals;
2) the self assembly of the coordination polymer;
3) the formation of nanoparticles by the reduction of metals from the organic ligand-metal complex;
4) the adhesion of organic ligands to the surface of the nanoparticles, and thus the stabilization of the nanoparticles; and
5) the adhesion of the nanoparticles to the surface of the self-assembled structure of the coordination polymer.

The formation of coordination polymer and the formation of nanoparticles can be performed using the same organic ligand-metal complex or two or more different organic ligand-metal complexes. Thus, in the present invention, the organic ligand-metal complexes may be used alone or in a mixture of two or more.

In the case where the formation of coordination polymer and the formation of nanoparticles are performed on the basis of the same precursors, it is preferable to control the amount of a reducing agent and the reaction time, such that an excess of the coordination polymer can be present in order to give rise to the above-described simultaneous reaction.

The formation of nanoparticles can be performed by reducing metal cations in a solution using the organic ligand-metal complex as a precursor, and when two or more organic ligand-metal complexes are used, alloy nanoparticles can also be formed. Also, the nanoparticles can be stabilized due to the adhesion of either the organic ligands, contained in the organic ligand-metal complex, or a separate surfactant, to the surface of the nanoparticles. Herein, the material that is attached to the surface of the nanoparticles is preferably an organic compound having both a hydrophobic group and a hydrophilic group.

As can be seen in the above-described example of Ag-palmitate, a hydrophobic group can be present on the surface of the self-assembled structure of the coordination polymer, and the surfactant attached to the nanoparticles may have a hydrophobic group present at the end thereof.

Accordingly, when the hydrophobic group attached to the surface of the nanoparticles interacts with the hydrophobic group exposed on the surface of the self-assembled structure of coordination polymer, the nanoparticles can more easily adhere to the surface of the self-assembled structure of the coordination polymer.

Method B) in Which Nanoparticles are Separately Prepared, and then are Attached

The method according to the present invention may comprise the steps of:
a) preparing nanoparticles, the surface of which has been stabilized by a surfactant;
b) dissolving a metal-organic ligand complex in a solvent, and then allowing the solution to react at a temperature of 25-250° C. so as to form a self-assembled structure of coordination polymer; and
c) adding the nanoparticles of step a) to the solution of step b) so as to attach the nanoparticles to the self-assembled structure.

In the step b) of this method, 1) the formation of coordination polymer by the coordination bonding between organic ligands and metal ions, and 2) the self-assembly of the coordination polymer, can simultaneously occur. Also, the nanoparticles prepared in the step a) can be attached to the surface of the self-assembled structure of the coordination polymer through the step c).

Moreover, the separately prepared nanoparticles may contain the same metal element as the metal element contained in the organic metal compound, but nanoparticles containing a metal element different from the metal element contained in the organic metal compound may also be applied in the present invention. In addition, the nanoparticles are not necessarily limited to metal nanoparticles, metal oxide or semiconductor compound nanoparticles may also be applied in the present invention.

Furthermore, although the surfactant attached to the surface of the nanoparticles may contain the same component as the organic component of the self-assembled structure of coordination polymer, it may also be a surfactant containing a component, which is not the same as the organic component of the self-assembled structure of coordination polymer, but can interact with the organic component to form an intermolecular bond.

In the step a), the preparation of the nanoparticles, the surface of which has been stabilized by a stabilizer, can be performed using any method known to those skilled in the art, and the method for preparing the nanoparticles is not specifically limited in the present invention.

For example, in the case of metal nanoparticles, a dispersion of metal nanoparticles can be obtained by adding a reducing agent to a solution, which contains a metal salt and a surfactant, dissolved therein, and allowing the solution to react at a suitable temperature so as to reduce metal cations to metal. Herein, the surfactant binds to the surface of the metal nanoparticles, thus serving to stabilize the metal nanoparticles.

Non-limiting examples of the metal salt include nitrate (NO₃⁻), halides (Cl⁻, Br⁻ and I⁻), oxyhydrate (OH⁻), sulfate (SO₄⁻), acetate (C₂H₃O₂⁻) and the like.

In the preparation of the nanoparticles, the surfactant serving to stabilize the surface of the nanoparticles is not specifically limited, as long as it is known to those skilled in the art. Surfactants are materials, which are adsorbed to interfaces in a solution to reduce the surface tension, and they are generally amphiphilic materials containing both a hydrophilic group and a lipophilic group in one molecule. Surfactants are classified, according to their ionic or non-ionic nature and active ingredient, into anionic surfactants, cationic surfactants, amphoteric surfactants and non-ionic surfactants. Non-limiting examples of the surfactant that is used in the present invention include polyvinyl pyrrolidone (PVP), polyethylene imine (PEI), poly methyl vinyl ether (PMVE), polyvinyl alcohol (PVA), polyoxyethylene alkyl phenyl ether, polyoxyethylene sorbitan monostearate or their derivatives, and palmitic acid. These surfactants may be used alone or in a mixture of two or more.

Although the process of separately preparing the nanoparticles has been described by way of an example of the process of preparing the nanoparticles by the reduction of metal salts, the scope of the present invention is not necessarily limited thereto, and in addition to said preparation method, metal nanoparticle preparation methods known to those skilled in the art may also be applied in the present invention. Also, the scope of the present invention is not limited to the preparation of metal nanoparticles, methods of preparing metal oxide or semiconductor compound nanoparticles, known to those skilled in the art, may also be applied in the present invention.

Meanwhile, the methods A) and B) may optionally comprise a step of heating and then cooling the solution containing the organic ligand-metal complex dissolved therein. In this case, the heating can be carried out at a temperature of 25-250° C. for 1 minute to 24 hours, and the cooling can be carried out either by naturally cooling the solution at room temperature or by rapidly cooling the solution using a cooling system.

The reducing agent that is used in the present invention is not specifically limited, as long as it reacts with the organic metal compound in a solution to form the nanoparticles. Non-limiting examples of such reducing agents may include strong reducing agents, such as NaBH₄, NH₂NH₂, LiAlH₄ and LiBEt₃H, polyols, such as dimethylforamide(DMF) and ethylene glycol, and amine compounds such as triethylamine (TEA).

The solvent that is used in the present invention is not specifically limited, as long as it is generally used in wet chemical reactions. Non-limiting examples of the solvent include water, methanol, ethanol, propanol, isopropanol, butanol, pentanol, hexanol, DMSO, DMF, ethylene glycol, ethylene glycol monomethyl ether, ethylene glycol monoethyl ether, ethylene glycol dimethyl ether, ethylene glycol diethyl ether, propylene glycol, propylene glycol propyl ether, propylene glycol methyl ether acetate, N-methyl pyrrolidone, methyl isobutyl ketone, methyl ethyl ketone, acetonitrile, THF, hexadecane, pentadecane, tetradecane, tridecane, dodecane, undecane, decane, nonane, octane, heptane, hexane, xylene, toluene, benzene and the like. These solvents may be used alone or in a mixture of two or more. Meanwhile, as described above, the benzene ring-containing solvent is more preferably in terms of solubility.

The self-assembled structure of coordination polymer may be in the form of a nanometer or micrometer-sized wire, plate, bar, sphere or cubic shape. Particularly, if the self-assembled structure is in the form of a wire, it may have a width of 10 nm to 10 μm and a length of 10 nm to 10 cm.

If the above-described self-assembled structures are formed by the self-assembly of unit molecules, it is important to control the shape and size of the structure. The shape and size of the structures can be controlled by various parameters, including the structure of building blocks in the coordination polymer, and reaction conditions in a solution, that is, the concentration and kind of reaction material, a catalyst, reaction temperature, etc.

The above-described self-assembled structure of coordination polymer, which have nanoparticles attached to the surface thereof, may have various shapes. For example, the self-assembled structure may be in the shape of a coordination polymer wire, which has a nanometer-sized width and a micrometer-sized length, and the surface of which is covered with nanoparticles, the shape of a micrometer-sized coordination polymer sphere, the surface of which is covered with nanoparticles, the shape of a micrometer-sized coordination polymer plate, the surface of which is covered with the nanoparticles, or the shape of a coordination polymer nanotube, which has a nanometer-sized width and length, and the surface of which is covered with nanoparticles.

The inventive self-assembled structure of coordination polymer, having nanoparticles attached to the surface thereof, can be used in various applications, including materials for electronic components, or templates for the synthesis of novel materials. For example, metal tubes can be prepared by covering the surfaces of self-assembled wire structures of coordination polymer with metal nanoparticles, and then subjecting the resulting structures to electroless plating using the metal nanoparticles as catalysts, and the size of the metal tubes can be controlled to the nanometer size or the micrometer size, depending on the size of the self-assembled structure of coordination polymer.

Moreover, core/shell tubes of metal/insulator can also be prepared by covering the surface of the wire-shaped self-assembled structure of coordination polymer with metal nanoparticles, and then subjecting the resulting structure to core shell synthesis using an insulator material as a material for forming shells.

In addition, metal wires can also be prepared by thermally calcining the wire-shaped self-assembled structure of coordination polymer, covered with metal nanoparticles.

However, the above-described applications of the self-assembled structure are merely illustrative, and the applications of the organic-inorganic hybrid structure of the present invention are not limited thereto.

### BRIEF DESCRIPTION OF THE DRAWINGS

FIG. 1 is a schematic diagram showing the formation and self-assembly of coordination polymer.

FIG. 2 is a schematic diagram showing another embodiment of the formation of coordination polymer.

FIG. 3 is a schematic diagram showing the principle in which nanoparticles are attached to the surface of a self-assembled structure of coordination polymer.

FIG. 4 is a scanning electron microscopy (SEM) photograph of a self-assembled structure of coordination polymer, which is an intermediate product of Example 2 and has no nanoparticles attached to the surface thereof.

FIG. 5 is a SEM photograph of a self-assembled structure of coordination polymer, which has nanoparticles attached to the surface thereof and was prepared according to the method of Example 1.

FIG. 6 is SEM and BSEM (back scattered electron microscopy) photographs of self-assembled structure of coordination polymer, which has nanoparticles attached to the surface thereof and was prepared according to the method of Example 1.

FIG. 7 is a transmission electron microscopy (TEM) photograph of which has nanoparticles attached to the surface thereof and was prepared according to the method of Example 1.

FIG. 8 is a transmission electron microscopy (TEM) photograph of which has nanoparticles attached to the surface thereof and was prepared according to the method of Example 2.

FIG. 9 is a transmission electron microscopy (TEM) photograph of which has nanoparticles attached to the surface thereof and was prepared according to the method of Example 3.

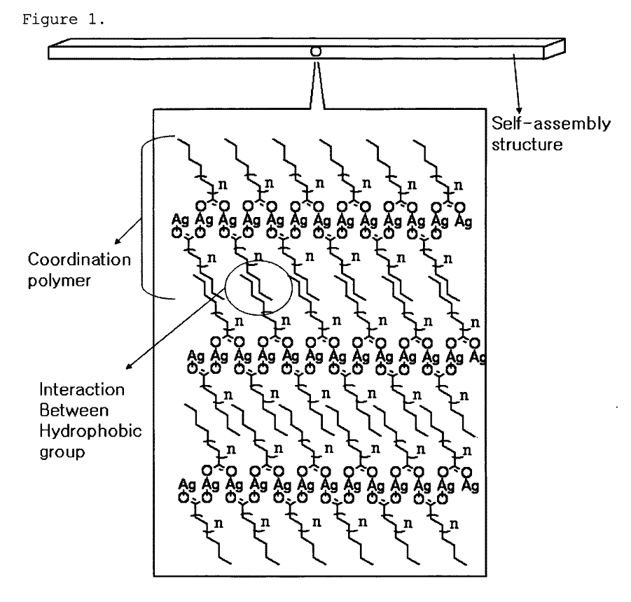

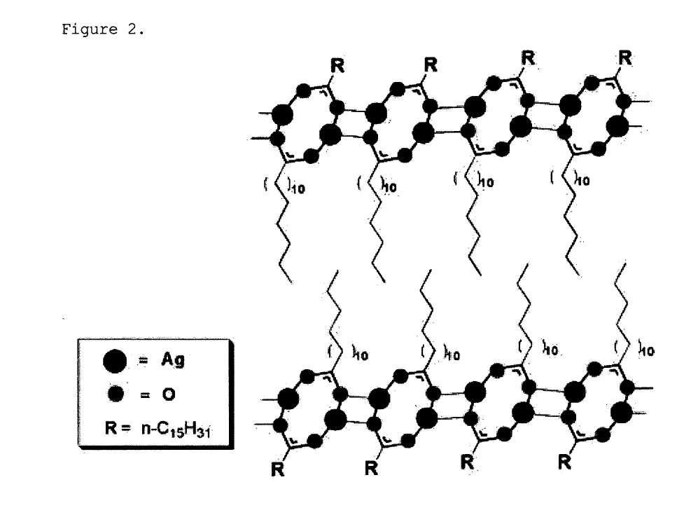

### BEST MODE FOR CARRYING OUT THE INVENTION

Reference will now be made in detail to the following examples. It is to be understood that the following examples are illustrative only, and the scope of the present invention is not limited thereto.

### Example 1

0.79 g of Ag-palmitate and 0.61 g of TEA (triethylamine) were dissolved in 50 ml of a toluene solvent, and the solution was refluxed at 110 C for 30 minutes, while N₂ gas was bubbled through the solution. As a result, a red-colored dispersion could be obtained, and 50 ml of acetone was added thereto. The resulting solution was washed, stirred, and centrifuged at 3400 rpm for 3 minutes. Then, 50 ml of hexane was added thereto, and the solution was washed, stirred, and centrifuged at 3400 rpm for 3 minutes.

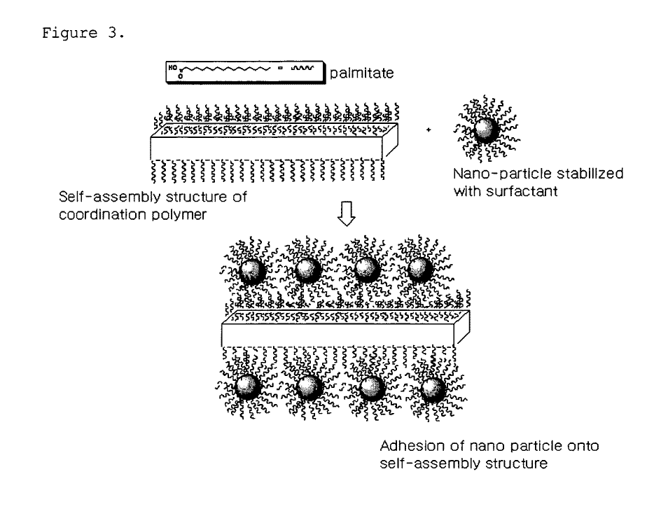

FIG. 3 schematically shows the process in which Ag nanoparticles are attached to the surface of a self-assembled structure of Ag-palmitate coordination polymer in this Example.

The Ag-palmitate dissolved in the solvent forms Ag nanoparticles by the reducing agent, and the palmitate separated during the reduction of Ag is attached to the surface of the Ag nanoparticles so as to serve as a surfactant, such that stable nanoparticles can be formed. Meanwhile, surplus Ag-palmitate, which was not reduced by the reducing agent, as the foregoing, forms a coordination polymer by the coordinate bonding between Ag and palmitate, and the coordination polymer is self-assembled into a structure having an alkyl chain as a hydrophobic group on the surface thereof, thus forming a microwire structure. Herein, the palmitate molecule attached to the surface of the Ag nanoparticles also has an alkyl chain located at the end thereof, and thus the Ag nanoparticles bind to the self-assembled structure of Ag-palmitate coordination polymer through interactions between the hydrophobic groups.

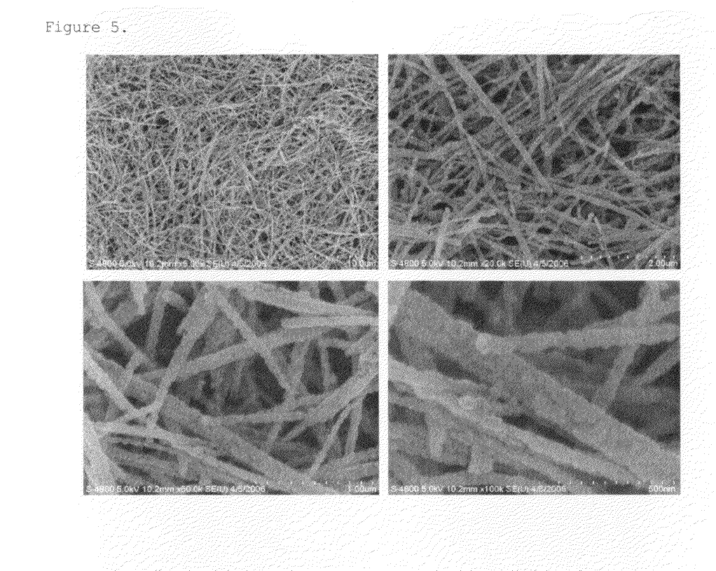

FIG. 5 shows a scanning electron microscopy (SEM) photograph of the self-assembled structure of Ag-palmitate coordination polymer, the surface of which is covered with Ag nanoparticles and which was prepared in this Example. From the SEM photograph, it could be observed that the surface of the self-assembled structure of Ag-palmitate coordination polymer was coated with Ag-nanoparticles having a size of about 10 nm.

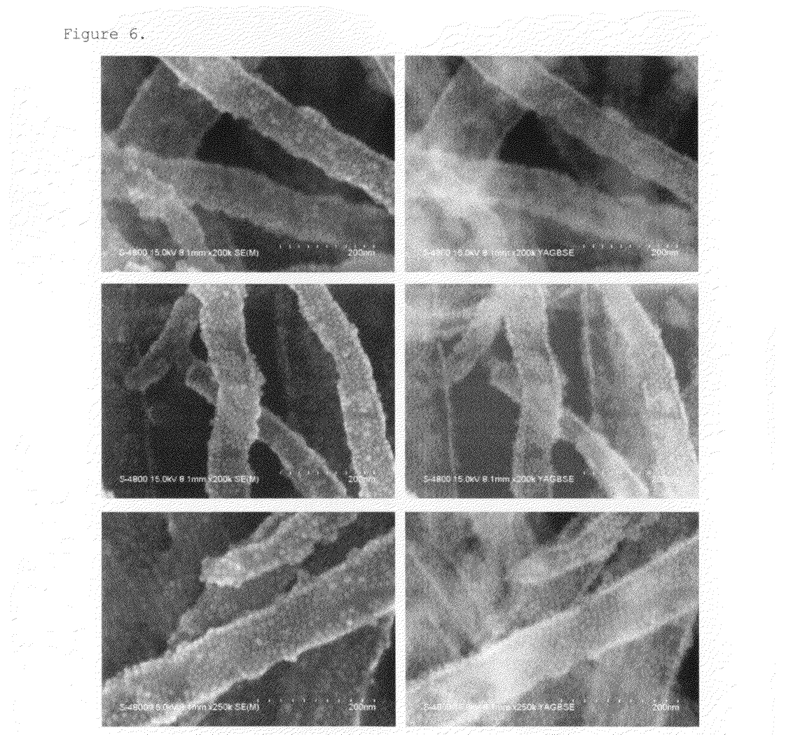

FIG. 6 shows a SEM photograph and BSEM photograph of the self-assembled structure of Ag-palmitate coordination polymer, the surface of which is covered with Ag nanoparticles and which was prepared in this Example. It can be seen in the BSEM photograph, nanoparticles were not distributed inside the self-assembled structure of coordination polymer, but the surface of the self-assembled structure.

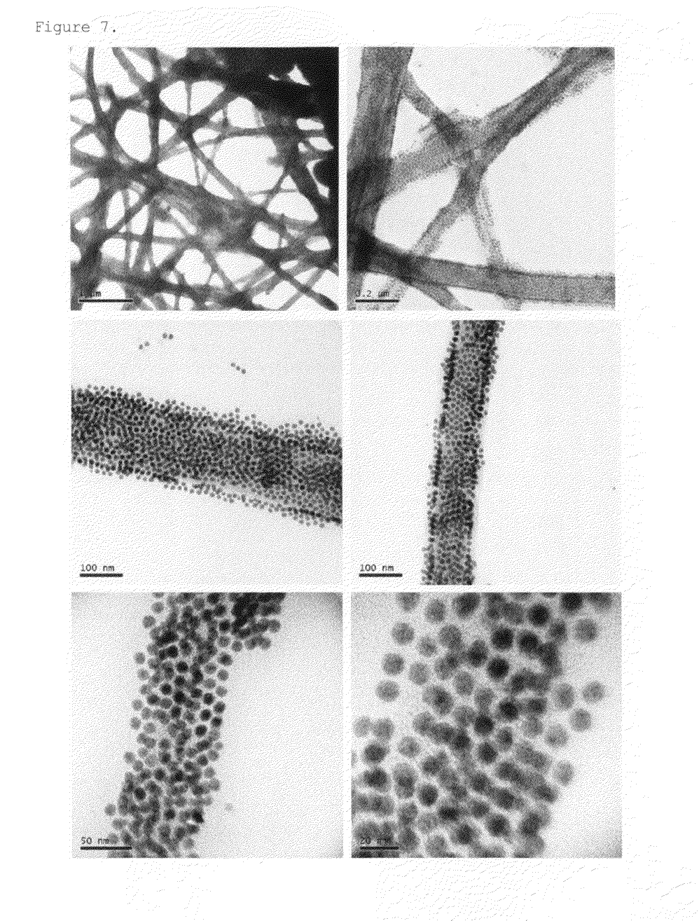

FIG. 7 shows a transmission electron microscopy (TEM) photograph of the self-assembled structure of Ag-palmitate coordination polymer, the surface of which is covered with Ag nanoparticles and which was prepared in this Example. As can be seen in the TEM photograph, the component of the micro-scale wire was not Ag, but coordination polymer, and Ag nanoparticles having a size of about 10 nm were uniformly attached to the surface of the coordination polymer.

### Comparative Example 1

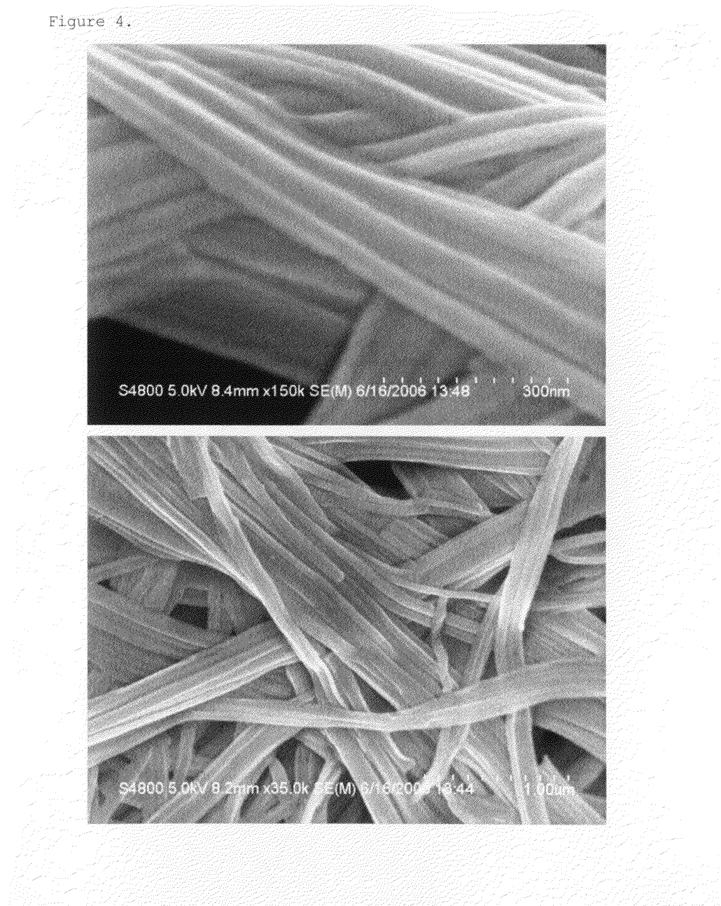

The process of Example 1 was repeated, except that TEA (triethylamine) was not added. As a result, a self-assembled structure of Ag-palmitate, having no Ag nanoparticles attached to the surface thereof, could be obtained, and a SEM photograph thereof is shown in FIG. 4.

### Example 2

5.6 g of palmitic acid was added to 40 ml of triethylamine and stirred for 20 minutes, and 3.6 g of AgNO₃ was added thereto. Then, the mixture was stirred for 2 hours to obtain a white slurry. The slurry was refluxed at about 80° C. for 2 hours and cooled. Then, 20 ml of acetone was added thereto, and the solution was centrifuged at 3200 rpm for 5 minutes to obtain Ag nanoparticles. The yield of the obtained Ag nanoparticles was 95%.

Meanwhile, 0.056 g of Ag-palmitate was dissolved in 25 g of a toluene solvent, and the solution was refluxed at 120° C. for 30 minutes, and then cooled to room temperature. As a result, a dispersion of a self-assembled structure of Ag-palmitate coordination polymer, having no nanoparticles attached thereto, could be obtained.

To the dispersion of the self-assembled structure dispersed therein, 0.005 g of the above-prepared Ag nanoparticles, which had a size of 5 nm or less and to which palmitic acid as a surfactant was attached to the surface thereof, were added. The mixture was stirred for 30 minutes, and then centrifuged at 3400 rpm for 3 minutes.

FIG. 4 shows a SEM photograph of the self-assembled structure of coordination polymer, having no nanoparticles attached thereto.

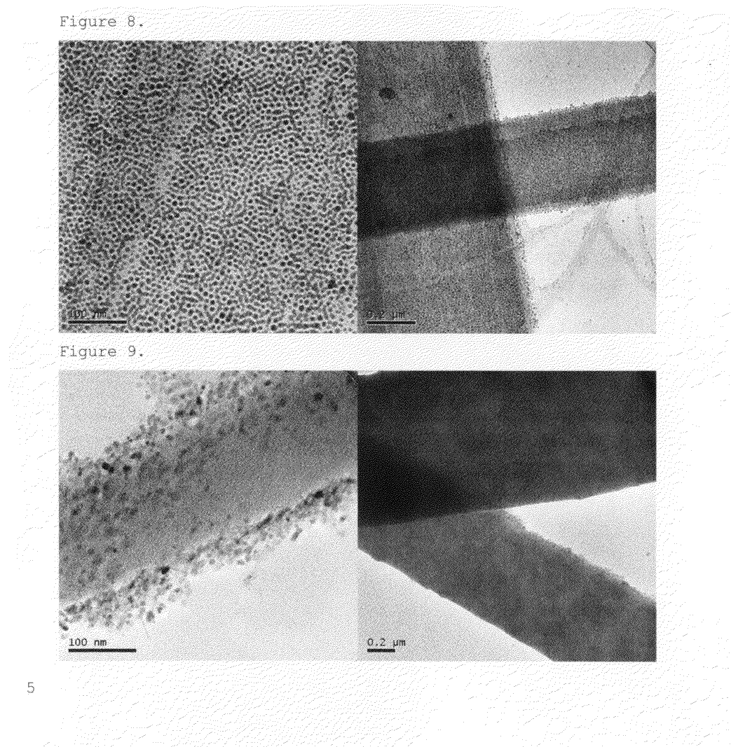

FIG. 8 shows a transmission electron microscopy (TEM) photograph of the self-assembled structure of Ag palmitate coordination polymer, which was prepared in Example 2 and the surface of which was covered with Ag nanoparticles. As can be seen in the TEM photograph, the component of the micro-scale wire was not Ag, but coordination polymer, and Ag nanoparticles having a size of about 5 nm were uniformly attached to the surface of the coordination polymer.

### Example 3

0.018 g of Ag-palmitate was dissolved in 25 g of a toluene solvent, and the solution was refluxed at 120° C. for 30 minutes, and then cooled to room temperature. As a result, a dispersion of a self-assembled structure of Ag-palmitate coordination polymer was dispersed could be obtained. To the dispersion, 0.050 g of ZnO nanoparticles, which had a size of 5 nm or less and to which palmitic acid as a surfactant was attached to the surface thereof, were added. The mixture was stirred for 30 minutes, and then centrifuged at 3400 rpm for 3 minutes.

FIG. 9 shows a transmission electron microscopy (TEM) photograph of the self-assembled structure of Ag palmitate coordination polymer, which was prepared in Example 3 and the surface of which was covered with ZnO nanoparticles. As can be seen in the TEM photograph, the component of the micro-scale wire was not ZnO, but coordination polymer, and ZnO nanoparticles having a size of about 5 nm were uniformly attached to the surface of the coordination polymer.

### INDUSTRIAL APPLICABILITY

As can be seen from the foregoing, according to the present invention, through the use of the self-assembly phenomenon of coordination polymer and the use of nanoparticles having a surface component, which is the same as or similar to that of the surface of the coordination polymer, an organic-inorganic hybrid structure, which has nanoparticles attached to the surface of a self-assembled structure of coordination polymer, can be prepared in a relatively simple process without needing several steps. The organic-inorganic hybrid structure, in which the surface of the self-assembled structure of coordination polymer is covered with nanoparticles, such as metal or semiconductor nanoparticles, can be used in various applications, including materials for electronic components, or templates for the synthesis of novel materials.

Although several preferred embodiments of the present invention have been described for illustrative purposes, those skilled in the art will appreciate that various modifications, additions and substitutions are possible, without departing from the scope and spirit of the invention as disclosed in the accompanying claims.

1. An organic-inorganic hybrid structure having nanoparticles attached to the surface thereof, wherein the structure comprises a self-assembled structure of a coordination polymer, which includes a metal-organic ligand complex.

2. The organic-inorganic hybrid structure according to claim 1, wherein the organic ligand is coordinately bonded to two or more metal atoms, and the coordinately bonded metal atoms are also coordinately bonded to one or more other organic ligands in a chain manner, thereby forming the coordination polymer.

3. The organic-inorganic hybrid structure according to claim 1, wherein two metal ions are bonded with two 2-coordionate organic ligands to form ring-shaped dimers, and the coordination polymer is formed through the bonding between the dimers.

4. The organic-inorganic hybrid structure according to claim 1, wherein the organic ligands have both a hydrophilic group and a hydrophobic group.

5. The organic-inorganic hybrid structure according to claim 1, wherein the organic ligands have both a hydrophilic group, selected from the group consisting of —COO, —NH₂, —CONH₂, —PO₃H₂, —SH, —SO₃H, —SO₂H, —NO₂, and —O(CH₂CH₂O)ₙH (n=an integer ranging from 1 to 5), and a hydrophobic group selected from the group consisting of a C₃-C₃₀ alkyl group and a C₃-C₃₀ aryl group.

6. The organic-inorganic hybrid structure according to claim 1, wherein the coordination polymer is formed through coordinate bonding of the hydrophilic group of the organic ligands to the metal atoms.

7. The organic-inorganic hybrid structure according to claim 1, wherein the self-assembly of the coordination polymer is achieved by the interaction between the hydrophobic groups of the coordination polymer.

8. The organic-inorganic hybrid structure according to claim 1, wherein the hydrophobic group or hydrophilic group of the organic ligands are located on the surface of the self-assembled structure.

9. The organic-inorganic hybrid structure according to claim 1, wherein metals contained in the metal-organic ligand complex are selected from the group consisting of metals, metalloids, lanthanide metals and actinide metals, which belong to groups 3-16 of the periodic table.

10. The organic-inorganic hybrid structure according to claim 1, wherein the nanoparticles have a size ranging from 1 nm to 500 nm and contain a material selected from the group consisting of the metals, metalloids, lanthanide metals and actinide metals, belonging to groups 3-16 of the periodic table, alloys of two or more of said elements, the oxides of said elements, and semiconductor compounds.

11. The organic-inorganic hybrid structure according to claim 1, wherein an organic compound, having a hydrophobic group or a hydrophilic group, is attached to the surface of the nanoparticles.

12. The organic-inorganic hybrid structure according to claim 11, wherein the end of the organic compound attached to the surface of the nanoparticles has a functional group, which is the same as a functional group present on the surface of the self-assembled structure or can interact with the functional group present on the surface of the self-assembled structure.

13. The organic-inorganic hybrid structure according to claim 11, wherein the nanoparticles are attached to the surface of the self-assembled structure through interaction between the functional group present on the end of the organic compound attached to the surface of the nanoparticles and the functional group present on the surface of the self-assembled structure.

14. The organic-inorganic hybrid structure according to claim 1, wherein the nanoparticles comprise the same metal element as a metal contained in the coordination polymer.

15. The organic-inorganic hybrid structure according to claim 1, wherein the self-assembled structure has a shape selected from the group consisting of a wire shape, a plate shape, a bar shape, a sphere shape and a cubic shape.

16. The organic-inorganic hybrid structure according to claim 1, wherein the self-assembled structure is in the form of a wire, which has a width ranging from 10 nm to 10 μm and a length ranging from 10 nm to 10 cm.

17. A method for preparing the organic-inorganic hybrid structure as defined in claim 1, which has nanoparticles attached to the surface of a self-assembled structure of coordination polymer, the method comprising the steps of:
a) dissolving a metal-organic ligand complex and a reducing agent in a solvent;
b) heating the solution at a temperature of 25-250° C. so as to allow it to react; and
c) cooling the reaction solution to room temperature.

18. The method according to claim 17, wherein 1) the self-assembly of metal-organic ligand coordination polymer, 2) the formation of metal nanoparticles, and 3) the adhesion of the nanoparticles to the surface of the self-assembled structure, simultaneously occur.

19. A method for preparing the organic-inorganic hybrid structure as defined in claim 1, which has nanoparticles attached to the surface of a self-assembled structure of coordination polymer, the method comprising the steps of:
a) preparing nanoparticles, the surface of which has been stabilized by a surfactant;
b) dissolving a metal-organic ligand complex in a solvent, and then allowing the solution to react at a temperature of 25-250° C. so as to prepare a self-assembled structure of coordination polymer; and
c) adding the nanoparticles of step a) to the solution of step b) so as to attach the nanoparticles to the self-assembled structure.

20. The method according to claim 17, wherein the solvent is a compound containing a benzene ring.

21. The method according to claim 18, wherein the solvent is a compound containing a benzene ring.

22. The method according to claim 19, wherein the solvent is a compound containing a benzene ring.
